(19) United States
(12) Patent Application Publication
(10) Pub. No.: US 2022/0256901 A1
(43) Pub. Date: Aug. 18, 2022

(54) BOTANICAL SUGAR SUBSTITUTE

(71) Applicant: B.T. Sweet Ltd, Ramat Gan (IL)

(72) Inventors: Yoel BENESH, Kokhav Ya'ir (IL); Gil DE PICCIOTTO, Zikhron Yaakov (IL)

(73) Assignee: B.T. Sweet Ltd, Ramat Gan (IL)

(21) Appl. No.: 17/617,621

(22) PCT Filed: Jun. 10, 2020
(86) PCT No.: PCT/IL2020/050643

§ 371 Date: Dec. 9, 2021

Related U.S. Application Data
(60) Provisional application No. 62/859,745, filed on Jun. 11, 2019.

(51) Int. Cl. A23L 27/30; A23L 27/10; A23L 33/21; A23L 2/60

(52) U.S. Cl. CPC A23L 27/36; A23L 27/10; A23V 2002/00; A23L 2/60; A23L 33/21

(57) ABSTRACT

Disclosed herein is an all-natural sugar substitute composition-of-matter, which includes an indigestible soluble fiber ingredient, a natural high-potency sweetening ingredient, a flavor-balancing ingredient, a taste-balancing ingredient, and a tiger nut product ingredient, which can replace sugar in any food, cosmetic or pharmaceutical product.

### RELATED APPLICATIONS

This application claims the benefit of priority of U.S. Provisional Patent Application No. 62/859,745 filed on 11 Jun. 2019, the contents of which are incorporated herein by reference in their entirety.

### FIELD AND BACKGROUND OF THE INVENTION

The present invention, in some embodiments thereof, relates to sugar substitutes and uses thereof, and more particularly, but not exclusively, to an all-natural cane-sugar substitute suitable for all uses.

Sugar substitutes are natural and/or synthetic food additives that simulate the sweet taste effect of sugar. Sweet tastes of natural and synthetic high-potency sweeteners are slower in onset and longer in duration than the sweet taste produced by sugar and thus change the taste balance of a food composition. Because of these differences, use of natural and synthetic high-potency sweeteners to replace a bulk sweetener, such as sugar, in a food or beverage, causes an unbalanced temporal profile and/or flavor profile. In addition to the difference in temporal profile, high-potency sweeteners generally exhibit lower maximal response than sugar, off tastes (e.g., bitter, metallic, cooling, astringent, licorice-like taste), tongue and oral cavity numbing/tingling, and/or sweetness that diminishes on iterative tasting. Some high potency sweeteners also exhibit dramatically different sweetness intensities as a function of temperature. It is well known to those skilled in the art of food/beverage formulation that changing the sweetener in a composition requires re-balancing of the flavor and other taste components. If the taste profile of natural and synthetic high-potency sweeteners could be modified to impart specific desired taste characteristics to be more sugar-like, the type and variety of compositions that may be prepared with that sweetener would be expanded significantly. Accordingly, it would be desirable to selectively modify the taste characteristics of natural and synthetic high-potency sweeteners.

Artificial sweeteners are synthetic sugar substitutes that may be derived from naturally occurring substances. Artificial sweeteners, such as Aspartame™, Sucralose™, and Saccharin™ are common alternatives to sugar because much less sweetener material is required as compared with the amount of sugar to achieve the same level of sweetness. Since many artificial sweeteners have higher levels of sweetness than sugar, they often have a different taste than that of sugar, frequently having a bitter or chemical aftertaste. In addition to not tasting like sugar, some sweeteners are made with glycemic, ingredients (such as maltodextrins) or synthetic additives or sugar alcohols or fructose in an effort to more similarly resemble sugar. However, artificial sweeteners still lack many of the properties and functions of sugar, such as sugar-like mouth feel and sugar-like binding and browning in baking, not to mention their adverse effects, such as their allergic and laxative effect.

Additionally, artificial sweeteners have been linked to an increase in diabetes, metabolic disease, neurotoxicity, carcinogenicity, and obesity as they have also been shown to adversely affect human gut bacteria. Artificial sweeteners have been specifically shown to increase the abundance of bacterial strains belonging to the Bacteroides genus and the Clostridiales order, both of which contain members linked to obesity, glucose intolerance, and opportunistic infections. In addition, artificial sweeteners are believed to interact with sweet taste receptors in the gut, which results in the release of insulin in the body. In addition to disrupting an individual's blood sugar levels, insulin spikes are known to increase fat stores and general inflammation resulting in a variety of health issues, associated with obesity and diabetes. As a result, high-intensity artificial sweeteners are of particular concern to educate consumers and individuals that already have elevated insulin or blood sugar levels. Thus, sugar substitutes derived from natural ingredients have been proposed as healthier alternatives to artificial sweeteners.

Currently known sugar substitutes may be derived from plants, fruit, vegetables, herbs, roots, and grains. However, these sugar substitutes, some of which claim to be derived from natural sources, such as Isomalt™, Stevia™, Truvia™, and Monatin™, still lack many of the properties, usability and functions of sugar. Some of these sugar substitutes only have between about 40% and 60% of the sweetness of sugar and have a notable metallic aftertaste, such as that of many Stevia™ extracts. Other natural sugar substitutes, such as Palatinose™, have a lower glycemic index than sugar, but provide the same amount 20 of calories per gram as found in sugar. Some natural sugar substitutes, such as those containing sugar alcohol varieties, often cause laxative and bloating side effects and therefore are limited for use to only a small serving per day. Also, many natural sugar substitutes use ingredients derived from genetically modified organisms (GMO) and do not include a fiber component. Similarly, in the sugar substitutes that do utilize soluble fiber as a starting material, fiber production is often produced from GMO ingredients.

Hitherto, commonly found natural sugar substitutes have used several ingredients, such as digestion resistant soluble fiber, Luo-han Guo extracts, and steviol glycosides, to replicate the various properties and characteristics of sugar. However, these attempts have not been successful in replicating the properties and characteristics of sugar. As a result, these ingredients typically require a combination thereof with fructose and/or sucrose, artificial ingredients, sugar alcohol, or maltodextrin in order to simulate sugar.

Accordingly, there exists a need for a sugar substitute composition comprising natural ingredients that can provide the added human health benefits and properties and characteristics of sugar, without the caloric content and glycemic index of sugar and/or sugar additives and without causing adverse digestive side effects.

The prior art includes documents such as, for example, WIPO Patent Applications WO 2015/042137, WO 2012/100991, WO 2017/075257, WO 2017/176873, WO 2018/229779 and WO 2018/229776, U.S. Pat. Nos. 8,512,793 and 8,524,303, United States Patent Application Publication Nos. 2007/0116819, 2014/0220220, 2016/0165941, 2017/0119032, 2017/0143022, 2017/0119032, 2011/0200712, 2016/0198750, 2009/0011104 and 2016/0242439, EP1815754 and EP1623630.

### SUMMARY OF THE INVENTION

The present invention describes embodiments of an all-natural sugar substitute comprising specific compositions of botanical components with distinct ratios therebetween that yield respective levels of sweetness, ranging from sucrose level to a level that is about thirty times sweeter than sucrose, however with a lower calorie content and a lower glycemic index than that of sucrose. Specifically, in some embodiments, the composition of ingredients in the sugar substitute comprises three botanical components: a soluble fiber carrier, a fruit or herbal derived ingredient for sweetening and a grain-hull derived ingredient for flavor balancing, all of which are preferably GRAS, preferably non-GMO, and preferably devoid of maltodextrin, sugar alcohol, stevia Reb-A or any stevia derivative, glycerin, soy, milk, peanuts and wheat, and preferably devoid of any known artificial sweetener.

In some embodiments, the sugar substitute may comprise some ingredients that would otherwise be excluded from the preferred composition but may be added due to, for example, common food processing methods. Such ingredients may include incidental additives in the manufacturing of the botanical components of the sugar substitute or incidental additives that are present in the botanical components with no technical function but are nevertheless present due to having been incorporated as an ingredient of another ingredient (such as a flavor for instance) where the additive substance have a function. Other examples of such ingredients may include processing aids that are often added during processing and may not have been fully removed, as well as otherwise excluded substances such as one or more of non-certified GRAS, non-certified non-GMO, maltodextrin, sugar alcohol, glycerin, soy, milk, peanut and wheat, each of which individually or in combination with others may be incorporated and listed on the label as making up no more than 2% of the content of the composition.

The sugar substitute presented herein is nutritive in that each version provides phytonutrients to the diet without causing adverse effects on gut flora such as those commonly associated with non-nutritive sweeteners. The sugar substitute composition presented herein is based on specific ratios between the sweetening ingredient and the flavor balancing ingredient, each of which yields a specific level of sweetness while maintaining a clean taste with no cooling or lingering effects, bitter, metallic, or licorice aftertaste such as that commonly associated with chemical sweeteners, stevia, sugar alcohol, allulose and pristine Luo-Han Guo. It is the unique combination of properties—all natural, clean taste and range of sweetness, that confers the desired characteristic of the composition disclosed herein, which is distinctively unique compared to conventional sugar substitutes, as it the only sugar substitute capable of fully replacing natural sugar, such as cane sugar, and all types of sweeteners in all industrial and consumer recipes without added fillers or binders. The combined properties of some embodiments of the present invention of a sugar substitute composition, may include:

Clean pleasant taste with no bitter, metallic, cooling or licorice aftertaste; Sweetness range from 1 to 30 sucrose equivalents;

Clean label available minimal ingredients versions derived from botanical sources (optionally non-GMO);

Available in version substantially devoid of maltodextrin, sugar alcohol, soy, peanuts and wheat;

Available in version substantially devoid of Stevia rebaudiana and derivatives thereof;

Can replace sugar “one-to-one” (by volume and/or weight) in all consumer and industrial recipes without added carriers, fillers or binder;

Available in versions with sugar-like binding properties that can be useful in baking and chocolate manufacturing; Can replace chemical sweeteners, sugar alcohols and stevia Rebaudioside A in all industrial recipes;

Least laxative;

Prebiotic, supports healthy gut bacteria;

Available in diabetic friendly versions;

Nutritive, promotes satiety;

High pH stability of 2-9 in some embodiments; and may reach 2-11 in other embodiments;

Heat stability at 200-250° C. in some embodiments; and

Low water activity (a_{w}) of 0.5-0.7, or less in some embodiments.

Thus, according to an aspect of some embodiments of the present invention there is provided a composition-of-matter, that includes:

an indigestible soluble fiber ingredient,

a natural high-potency sweetening ingredient,

a tiger nut product.

In some embodiments of the invention, the composition-of-matter further includes:

a flavor-balancing ingredient; and

a taste-balancing ingredient.

In some embodiments of the invention, the indigestible soluble fiber ingredient is selected from the group consisting of an isomaltooligosaccharide, an inulin, a digestive resistant dextrin, and a digestive resistant maltodextrin.

In some embodiments of the invention, the natural high-potency sweetening ingredient is selected from the group consisting of a Siraitia grosvenorii derived substance, a luo-han guo extract, a mogroside and esgoside.

In some embodiments of the invention, the tiger nut product ingredient is selected from the group consisting of powdered tiger nuts, sliced/chopped tiger nuts and mashed tiger nuts.

In some embodiments of the invention, the flavor-balancing ingredient is selected from the group consisting of a Vanilla planifolia derived substance, a natural vanillin and a citrus oil extract.

In some embodiments of the invention, the taste-balancing ingredient is an organic acid.

In some embodiments of the invention, the organic acid is citric acid.

In some embodiments of the invention, in the composition-of-matter presented herein:

the concentration of the indigestible soluble fiber ingredient ranges 94-98 weight percent;

the concentration of the natural high-potency sweetening ingredient ranges 0.5-2.2 weight percent; and

the concentration of the tiger nut product ingredient ranges 0.5-2 weight percent of the total weight of the composition-of-matter.

In some embodiments of the invention, in the composition-of-matter presented herein: the indigestible soluble fiber ingredient is chicory and/or tapioca isomaltooligosaccharide; and

the natural high-potency sweetening ingredient is luo-han guo extract.

In some embodiments of the invention, in the composition-of-matter presented herein:

the concentration of the flavor-balancing ingredient ranges 0.1-1.0 weight percent; and

the concentration of the taste-balancing ingredient ranges 0.1-1.5 weight percent of the total weight of the composition-of-matter.

In some embodiments of the invention, the composition-of-matter presented herein is substantially devoid of a sugar alcohol.

In some embodiments of the invention, the composition-of-matter presented herein is substantially devoid of an artificial or synthetic sweetener.

In some embodiments of the invention, the composition-of-matter presented herein is substantially devoid of a steviol glycoside, or any Stevia rebaudiana-derived substance.

In some embodiments of the invention, the composition-of-matter presented herein is characterized by inducing a glycemic response that is lower than a glycemic response induced by sucrose in healthy adult humans.

In some embodiments of the invention, the composition-of-matter presented herein is packaged in a packaging material and identified in print for use as a sugar substitute.

In some embodiments of the invention, the mass and/or volume unit of the sugar substitute presented herein is equivalent to the mass and/or volume unit of sugar.

According to an aspect of some embodiments of the present invention, there is provided a food product includes the composition-of-matter provided herewith.

In some embodiments of the invention, the food product is substantially devoid of a sugar alcohol.

In some embodiments of the invention, the food product is substantially devoid of an artificial or synthetic sweetener.

In some embodiments of the invention, the food product is substantially devoid of a steviol glycoside, or any Stevia rebaudiana-derived substance.

In some embodiments of the invention, the food product is having a glycemic index lower than 35.

In some embodiments of the invention, the food product is selected from the group consisting of a pastry product, a dairy product, a beverage, and a cooked product.

According to an aspect of some embodiments of the present invention, there is provided a cosmetic or pharmaceutical composition includes the composition-of-matter provided herewith.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents comparative spider diagrams of the sensory profile afforded for butter cookies category comparing 6G335B (dashed line) to Sugar (solid line);

FIG. 2 presents comparative spider diagrams of the sensory profile afforded for chocolate cake category comparing 6G335B (dashed line) to Sugar (solid line);

FIG. 3 presents comparative spider diagrams of the sensory profile afforded for hot tea category comparing 6G335B (dashed line) to Sugar (solid line);

FIG. 4 presents comparative spider diagrams of the sensory profile afforded for cold coffee with milk category comparing 6G335B (dashed line) to Sugar (solid line); and

FIG. 5 presents comparative spider diagrams of the sensory profile afforded for cold coffee with milk category comparing 6G335B (dashed line) and 6G335B without tiger nut (dotted line) to Sugar (solid line).

### DESCRIPTION OF SOME SPECIFIC EMBODIMENTS OF THE INVENTION

The present invention, in some embodiments thereof, relates to sugar substitutes and uses thereof, and more particularly, but not exclusively, to an all-natural cane-sugar substitute suitable for all uses.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

While conceiving the present invention, the present inventor has contemplated a botanical sugar substitute that will have the visual appearance, texture, taste and usability of typical cane sugar, without sacrificing any of the desired properties of cane sugar. Serendipitously, a composition-of-matter was unexpectedly discovered by the inventor when a high potency sweetener (sugar substitute), with a sweetness level of sucrose, was mixed with a tiger nut product; the resulting mix unexpectedly yielded a cane sugar flavor. The manufacturing of this cane sugar substitute version with sweetness level equivalent to that of sucrose, required a specific ratio between the sweetening component, a luo-han guo product, and the flavor/taste component mix of citric acid, vanillin and tiger nut product. To yield a sucrose level of sweetness along with a clean taste, it was found that the indigestible soluble fiber ingredient, should be of at concentration range of 94-98 wt. %, the natural high-potency sweetening ingredient, namely the luo-han guo product, should be of at concentration range of 0.5-2.2 wt. %, whereas to mask the aftertaste thereof, the flavor/taste component was a combination of citric acid, vanillin and tiger nut product, present at the concentration range of 0.7-4.5 wt. % of the total weight of the composition.

While reducing the present invention to practice, the inventor has developed a composition-of-matter which comprises a sugar substitute variety where all embodiments thereof are based on four basic botanical components: a natural high-potency sweetening ingredient, an indigestible soluble fiber ingredient, a flavor-balancing ingredient such as vanilla, tiger nut, and an organic acid such as citric acid. It was surprisingly found that the inclusion of a tiger nut product afforded a product with unprecedented resemblance to cane sugar. In addition it was found that the process of preparing the composition-of-matter presented herein also contributes to the performance of the final product.

A Natural High-Potency Sweetening Ingredient:

According to some embodiments of the present invention, the composition-of-matter presented herein includes a natural high-potency sweetening ingredient.

As used herein, the phrase “natural high-potency sweetening ingredient” (NHPS ingredient) refers to any sweetener found in nature which may be in raw, extracted, purified, or any other form, singularly or in combination thereof and characteristically have a sweetness potency similar to, equal to or greater than sucrose, fructose, or glucose, yet have less calories. Non-limiting examples of NHPS ingredients include, without limitation, mogroside II, mogroside III, mogroside V, mogro side VI, isomogroside V, 11-oxomogroside, siamenoside, luo-han guo extract in various concentrations of mogrosides, and other luo-han guo extract components, monatin and its salts (monatin SS, RR, RS, SR), curculin, glycyrrhizic acid and its salts, abiziasaponin, abrusosides, in particular abrusoside A, abrusoside B, abrusoside C, abrusoside D, albiziasaponin, bayunosides, in particular bayunoside 1, bayunoside 2, brazzein, bryoside, bryonoside, bryonodulcoside, carnosifloside, carrelame, cyanin, chlorogenic acid, dihydroquercetin-3-acetate, dihydroflavenol, gaudichaudioside, gypenoside, hematoxylin, lugduname, magap, micraculin, naringin dihydrochalcone (NarDHC), pentadin, perillartine, polpodiosides, polypodoside A, scandenoside, selligueanin A, sucronate, sucrooctate, telosmoside D-tryptophane thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, modification or derivatives thereof rebaudioside A, rebaudioside B, rebaudioside C, rebaudioside D, rebaudioside E, rebaudioside F, rebaudioside M (sometimes referred to rebaudioside X), dulcoside A, dulcoside B, rubusoside, stevia, stevioside, other steviol glycoside extract components, and the like. In an embodiment, the stevia glycosides can be stevia derived and/or produced through fermentation techniques. NHPS ingredients also includes modified NHPSs, which can include NHPSs which have been altered naturally or synthetically. For example, a modified NHPS includes NHPSs that have been fermented, contacted with enzyme, or derivatized or substituted on the NHPS. For the sake of brevity, in the description of embodiments, a modified NHPS is not expressly described as an alternative to an unmodified NHPS, but it should be understood that modified NHPSs can be substituted for NHPSs in any embodiment disclosed herein.

Most NHPSs have taste defects, e.g., lingering sweetness, bitterness, metallic taste, and the like. In fact, all NHPSs, including artificial compounds such as aspartame, sucralose, acesulfame potassium, saccharin, cyclamate, and the like, all have significant taste defects and adaptation phenomena such as late sweetness onset relative to sucrose, lingering sweetness, bitterness, metallic taste, and astringency. While also used as sugar reducers or replacers, they have been accepted by subsets of the population in order to remove or significantly reduce sugar in their diets.

In some embodiments of the present invention the high-potency sweetening ingredient may comprise a fruit and/or herbal derived extract. In some embodiments of the present invention the NHPS ingredient is a luo-han guo product. The luo-han guo product is derived from the Siraitia grosvenorii plant comprising 25-95% mogrosides, and particularly mogroside V. Mogrosides constitute a family of glycosides of cucurbitane derivatives, or terpenoid glycoside phytonutrients, esgosides, and include mogroside V (also referred to as mogroside 5), mogroside II A₁, mogroside II B, 7-oxomogroside II E, 11-oxomogroside A₁, mogroside III A₂, 11-deoxymogroside III, 11-oxomogroside IV A, 7-oxomogroside V, 11-oxo-mogroside V, and mogroside VI. The extract of such terpenoid glycoside phytonutrients is typically sweeter than sugar, yet induce very low glycemic response and very low calorie content.

In some embodiments of the present invention the high-potency sweetening ingredient is selected from the group consisting of: mogroside IV, mogroside V, Luo-han Guo sweetener, siamenoside, other components of Luo-han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, modification or derivatives thereof, and a combination thereof.

In some embodiments, the high-potency sweetening ingredient is monk fruit extract, which is a natural product extracted from Siraitia grosvenorii (luo-han guo), and includes 25-95% mogroside V, and is tested to be 150-200 time as sweet as sugar. Monk fruit extract (synonymously used herein with luo-han guo extract) is also selected for being heat stable, non GMO, Kosher and GRAS certified. In addition, sweeteners made with monk fruit extract do not impact blood sugar levels, and carry substantially no calories. Unlike some artificial sweeteners, there is no evidence to date showing that monk fruit extracts has negative side effects, and they are recognized as safe for children, pregnant women, and breast-feeding women. Monk fruit extracts are available in liquid, granule, and powder forms.

In some embodiments, the luo-han guo product is a Siraitia grosvenorii derived substance, a luo-han guo extract, a mogroside and an esgoside.

One of the few drawbacks of luo-han guo products, mogrosides and monk fruit extracts used as high-potency sweetening ingredient is a notable aftertaste, and the composition-of-matter presented herein provides a solution to this problem, in the form of a specific combination thereof with a flavor-balancing ingredient.

Tiger Nut Product Ingredient:

As discussed hereinabove, the composition-of-matter disclosed herein was found to be superior to previously disclosed compositions due to the inclusion of a tiger nut product therein, and particularly dried and grounded tiger nut powder. In the context of embodiments of the present invention, the term “tiger nut product” refers to a preparation afforded from the genus Cyperus esculentus, which is also referred to as chufa sedge, nut grass, yellow nutsedge, tiger nut sedge, edible galingale, water grass or earth almond. C. esculentus is mostly cultivated for its edible tubers, called earth almonds or tiger nuts, for the preparation of a sweet, milk-like beverage. Tiger nut products include, without limitation, raw dried and grounded tiger nuts (flour; powder), tiger nut bits and/or slices, tiger nut purée and/or mash and instant tiger nut preparations.

A Flavor-Balancing Ingredient:

According to some embodiments of the present invention, the composition-of-matter presented herein includes a flavor-balancing ingredient. The flavor-balancing ingredient is included in the composition-of-matter presented herein to mitigate the aftertaste and undesired organoleptic response caused by the high potency sweeter. The flavor-balancing ingredient, according to some embodiments of the present invention, may comprise natural vanillin derived from vanilla pods, clove, eugenol, nutmeg, cinnamon or turmeric; and/or a combination of vanillin and other botanical ingredients; and/or a citrus extract from lemon oil or another type of citrus oil and/or combination of citrus oil extract and other botanical ingredients.

In some embodiments, the citrus extract may comprise a 5-10 folded citrus oil extract that may be mixed with a single strength citrus oil extract in a ratio of 9 to 1 or similar ratios. Other flavor-balancing ingredient, according to some embodiments of the present invention, may comprise extracts or powders derived from ginger, cinnamon, pepper, allspice, nutmeg, rosemary, sage, thyme, oregano, rosemary, cardamom, chamomile, basil, bay leaf, banana, berries, papaya, melon, pineapple, coconut, cactus, peanuts, apple, pumpkin, carrot, beet, sweet potato, baobab, cassava, arrowroot, rice germ, rice bran, oat bran, lemon balm, lemon grass, cane sugar husk, pomegranate, acai, citrus, turmeric, coffee, cocoa, green tea, black tea and, the likes.

In some embodiments, the flavor-balancing ingredient is vanilla. The term “vanilla”, as used herein, encompasses all sorts of vanilla flavoring products, such as natural vanillin derived from vanilla pods that is part of the vanilla orchid, vanilla extract, vanilla essence or any natural vanilla flavoring ingredient. It is noted herein that the vanilla-based flavor-balancing ingredient includes vanillin (4-hydroxy-3-methoxybenzaldehyde), which is characterized by an aldehyde functional group. Without being bound by any particular theory, it is assumed that the aldehyde functionality of vanillin interacts with certain functionalities found naturally in mogrosides and other terpenoids glycosides comprising compounds such as steviosides, whereas the product of such interaction confers the desirable taste-masking attribute to the composition-of-matter provided herein.

In general, vanillin should be preferably derived from botanical sources such as vanilla orchids, clove, turmeric, nutmeg, plant eugenol and sugar. Wood lignins, microbial vanillin and petroleum-based eugenols are less desirable sources.

A Taste-Balancing Ingredient:

According to some embodiments of the present invention, the composition-of-matter presented herein includes a taste-balancing ingredient. The taste-balancing ingredient is included in the composition-of-matter presented herein to mitigate the aftertaste and undesired organoleptic response caused by the high potency sweetener, particularly the lingering sweetness that characterizes some of the natural high potency sweeteners. The taste-balancing ingredient, according to some embodiments of the present invention, includes edible bases, acids and salts thereof. In the context of some embodiments of the present invention the taste-balancing ingredient is an organic acid, and preferably citric acid. The taste-balancing ingredient may also be used to set a desired pH level of the composition-of-matter provided herein.

An Indigestible Soluble Fiber Ingredient:

According to some embodiments of the present invention, the composition-of-matter presented herein includes an indigestible soluble fiber ingredient. The indigestible soluble fiber ingredient includes a substance referred to herein as an isomaltooligosaccharide, or IMO. In the context of embodiments of the present invention, IMO is a mixture of short-chain carbohydrates (fibers) that constitute a matrix of glucose oligomers (oligosaccharides) having α-D-(1,6) linkage (“iso” linkage) of various chain length, ranging from 2 to 9 saccharides linked together. In the context of embodiments of the present invention, IMO is digestion-resistant, namely a mixture of nutritional fibers that are ingestible yet indigestible; thus, ingestion of IMO is likely to contribute little to the caloric value of foods, and induce a low glycemic response in a subject (35±8 on a scale of 1-100). In general, a glycemic response refers to the changes in blood glucose after consuming/ingesting a carbohydrate-containing food, unlike available carbohydrates that are actually digested and absorbed into the blood, metabolized and induce a high glycemic response (>50 on a scale of 1-100).

IMOs are found naturally in all plants, and the raw material used for manufacturing IMO is typically starch, which is enzymatically converted into a mixture of isomaltooligosaccharides. According to some embodiments of the present invention, the IMO is a GRAS (Generally Recognized As Safe) food ingredient, which is afforded from crops like chicory, acacia, tapioca, corn, milk, banana, pulses (peas, beans, lentils), rice, potato and the likes.

In some embodiments, the indigestible soluble fiber ingredient is IMO produced from chicory, corn, potato, acacia and/or tapioca.

Alternatively, in some embodiments, IMO can be replaced by an inulin as an indigestible soluble fiber ingredient. Inulins constitute a group of naturally occurring fructose oligosaccharides produced by many types of plants, and are most often extracted from chicory or Jerusalem artichoke. Because of the β(2,1) linkages, inulins are not digested by enzymes in the human alimentary system, contributing to its functional properties: reduced calorie value, dietary fiber and prebiotic effects. Thus, inulins belong to a class of dietary fibers known as fructans, and are considered as indigestible soluble fiber ingredient in the context of embodiments of the present invention. Inulin is used by some plants as a means of storing energy and is typically found in roots or rhizomes, and most plants that synthesize and store inulin do not store other forms of carbohydrate such as starch.

Alternatively and/or additionally, the indigestible soluble fiber ingredient may include digestive resistant dextrin and digestive resistant maltodextrin.

In some embodiments, the indigestible soluble fiber ingredient may further include cellulose (e.g., from plants) and/or pectin (e.g., from apples) and/or IMO varieties derived from, for example, potato, pumpkin or banana, and in some cases also milk.

A Composition-of-Matter:

Sucrose exhibits a sweet taste in which the maximal response is perceived quickly and where perceived sweetness disappears relatively quickly on swallowing a food or beverage. In contrast, the sweet tastes of essentially all high-potency sweeteners reach their maximal responses somewhat more slowly and they then decline in intensity more slowly than is the case for sucrose. This decline in sweetness is often referred to as “sweetness linger”, or “sweetness lingering effect”, and is a major limitation for many natural high-potency sweeteners, whereas slow onset of sweetness also can be a problem.

Sucrose is not known to exhibit any bitterness or mouth/tongue coating, or numbing/tingling effect; all of these attributes are considered problematic, negative sensory effects, or “taste defects”, in this discussion, particularly those of lingering or intensifying nature.

NHPSs such as monk fruit extract and stevia, are known to have a number of taste defects and reduced sweetening power (maximum achievable sweetness intensity) relative to sugars and other high potency sweeteners, including delayed sweetness onset, bitterness, soapy taste, lingering sweetness, carryover sweetness, and recurring sweetness. In addition, a typical NHPS has a distinct sensory defect in that, in some subjects and in some instances, it leaves the tongue and overall oral cavity with a sticky, coated feeling and sometimes a numb sensation on the tongue that only subsides after significant water or other food exposure. In extreme cases, sweetness linger can last for more than 15 minutes. In extreme cases, minutes are required before the full sensation of the tongue returns. NHPSs are currently and most commonly used as sugar reduction tools and can work acceptably in products that contain some level of sugars or sugar alcohols. However, in order for NHPSs to be used to provide even more and eventually all of the sweetness in many consumer products, significant progress must be made to modify their taste profile, temporal profile and adaptive behaviors.

Embodiments of the present invention can address problems associated with taste defects of the natural high-potency sweetener. As a result, compositions-of-matter according to embodiments of the present invention exhibit significant improvement in taste defects, and have a temporal profile more similar to a sugar temporal profiles.

As used herein, “temporal profile” of a composition means the intensity of sweetness perceived over time in tasting of a composition by a human.

In some embodiments, the composition-of-matter presented herein can exhibit a more cane sugar-like temporal and/or sugar-like flavor profile by including tiger nut therein, thereby improving taste profile and can suppress, reduce or eliminate one or more of the undesirable taste defects of natural high-potency sweeteners and impart sugar-like characteristics to the composition-of-matter.

Some embodiments of the present invention provide methods for suppressing, reducing, or eliminating taste defects of a NHPS and impart sugar-like characteristics by including a tiger nut product in composition including the NHPS to form the composition-of-matter presented herein.

As used herein, the phrases “sugar-like characteristic”, “sugar-like taste”, “sugar-like sweet”, “sugary”, and “sugar-like” are synonymous and are used interchangeably. Sugar-like characteristics include any characteristic similar to that of sucrose and include, but are not limited to, maximal response, flavor profile, temporal profile, adaptation behavior, mouthfeel, concentration/response function behavior, tastant and flavor/sweet taste interactions, spatial pattern selectivity, and temperature effects. These characteristics are dimensions in which the taste of sucrose is different from the tastes of natural and synthetic high-potency sweeteners. Whether or not a characteristic is more sugar-like is determined by expert sensory panel assessments of sugar, whereas such assessments quantify similarities or differences of the characteristics of a composition with those comprising sugar. Suitable procedures for determining whether a composition has a more sugar-like taste are well known in the art.

As exemplified in the Examples section that follows below, the characteristics of the presently provided composition-of-matter are attributed to the ingredients and to the delicate balance therebetween, namely to the ratio of their content in the composition.

In general, unless specified otherwise, all ingredients are in a dry form, at least for the relative amount consideration, which is discussed in terms of weight percentage relative to the total weight of the composition. In some embodiments, one or more of the ingredients may be a liquid, a syrup, or a concentrated solution, and the amounts thereof refer to the weight percentage of the liquid, or to the total dissolved solid in the syrup/solution assuming the solvent is water or alcohol and that the solvent is releasable.

As demonstrated below, the composition-of-matter presented herein can be formulated to afford a product that resembles cane sugar in its sweetness, consistency and usability (functions); this particular embodiment of referred to herein as “sugar level substitute”, “sucrose level substitute”, or a “one-to-one” sugar substitute, namely 1 spoon (or 1 gram) of sugar is replaceable with 1 spoon (or 1 gram) of an embodiment of the composition-of-matter presented herein.

Since the composition-of-matter presented herein can be prepared with a desired particle size distribution and to some extent particle shape, the specific gravity thereof can be tuned to resemble that of natural sugar products, whether they are for home or commercial use. Thus, in some embodiments, particularly where the composition-of-matter presented herein is used for commercial, semi-industrial, and industrial purposes, one practical formulation would exhibit sugar-like sweetening level and other physical and mechanical properties when rationed by weight, or in other words, a “by weight” formulation. For home and private uses, a “by volume” formulation would be more practical, as most home and private uses of sugar are rationed by volume (teaspoon, cup etc.).

Alternatively and additionally, the composition-of-matter presented herein can be in a form having a high-intensity sweetness equivalent of up to approximately 30-times sugar (sucrose) level. These embodiments are referred to herein as “high-intensity sweetener substitute”.

Thus, according to some embodiments of the present invention, the composition-of-matter presented herein in its sugar level substitute (one-to-one) embodiment, includes:

an indigestible soluble fiber ingredient, 94-98 wt. %;

a high-potency sweetening ingredient, 0.5-2.2 wt. %;

a flavor-balancing ingredient, 0.1-1.0 wt. %;

a taste-balancing ingredient, 0.1-1.5 wt. %; and

a tiger nut product ingredient, 0.5-2 wt. %.

According to other embodiments of the present invention, the composition-of-matter presented herein in its high-intensity sweetener substitute embodiment, includes:

an indigestible soluble fiber ingredient, 1-85 wt. %, or 5-25 wt. %;

a high-potency sweetening ingredient, 3-96 wt. %, or 50-70 wt. %;

a flavor-balancing ingredient, 2-30 wt. %, or 15-20 wt. %;

a taste-balancing ingredient, 2-30 wt. %, or 15-20 wt. %; and

a tiger nut product ingredient, 2-30 wt. %, or 15-20 wt. %.

It is to be understood that embodiments of the present invention encompass compositions-of-matter having all intermediate values of ingredients' contents, namely compositions-of-matter that are twice as sweet as sugar, 5-times, 10-times, 15-times, 20-times, 25-times, 30-times, 40-times and 50-times sweeter than sugar, wherein the ratio of the ingredients is maintained according to an interpolation between the “sugar level substitute” and the “high-intensity sweetener” embodiments. For example, the ratio of the flavor-balancing ingredient and the grain hull ingredient is kept at a range of 0.1:1 to 1:1, whereas the content range of the high-potency sweetening ingredient goes from 0.5-2 wt. % to 50-90 wt. % of the composition, and the indigestible soluble fiber ingredient makes up to Q.S. of 100 wt. %.

The composition can be supplemented with various optional and additional ingredients, which are used to confer particular properties to the composition-of-matter, such as flavoring agents, dairy-derived ingredients (e.g., dried milk), salts, thickeners, anticaking agents, antioxidants and coloring agents. Such optional ingredients are selected and quantified so as not to augment the desired flavor and functionality of the composition-of-matter.

According to some embodiments, the composition-of-matter presented herein is substantially devoid of an artificial or synthetic sweetener. As used herein, the phrase “artificial or synthetic sweetener” refers to any substance that is not found in nature and characteristically have a sweetness potency greater than sucrose, fructose, or glucose, yet have less calories. Non-limiting examples of artificial or synthetic sweeteners relevant in the context of embodiments of the present invention include, without limitation, advantame, sucralose, potassium acesulfame, aspartame, alitame, saccharin, cyclamate, neotame, N-[N-[3-(3-hydroxy-4-methoxyphenyl)propyl]-L-α-aspartyl]-L-phenylalanine 1-methyl ester, N-[N-[3-(3-hydroxy-4-methoxyphenyl)-3-methylbutyl]-L-α-asp artyl]-L-phenylalanine 1-methyl ester, N-[N-[3-(3-methoxy-4-hydroxyphenyl)propyl]-L-α-aspartyl]-L-phenylalanine 1-methyl ester, salts thereof, and the like.

According to some embodiments, the composition-of-matter presented herein is essentially devoid of a sugar alcohol, and more specifically, essentially devoid of sugar alcohol having 3-30 carbon atoms. Common sugar alcohols include, ethylene glycol (2-carbon), glycerol (3-carbon), erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), maltotriitol (18-carbon), and maltotetraitol (24-carbon). It is noted herein that an IMO, as defined hereinabove, is not included in the category of sugar alcohols.

According to some embodiments, the composition-of-matter presented herein is essentially devoid of any stevia derivative, stevioside, or other steviol glycoside extract components, including any natural, modified, derivative or a synthetic form thereof. In some embodiments, the high-potency sweetening ingredient is not selected from the group consisting of steviolbioside, stevioside, rebaudioside A, rebaudioside B, rebaudioside C, rebaudioside D, rebaudioside E, rebaudioside F, rebaudioside M/X, rubusoside, dulcoside A, dulcoside B, and a combination thereof.

According to an embodiment of the present invention, the composition-of-matter presented herein comprises, consists exclusively of, consists essentially of, or consists substantially exclusively of the following ingredients: an indigestible soluble fiber ingredient, a natural high-potency sweetening ingredient, a flavor-balancing ingredient, a taste-balancing ingredient, and tiger nut ingredient.

In some embodiments of the present invention, the composition-of-matter presented herein comprises, consists exclusively of, consists essentially of, or consists substantially exclusively of chicory and/or tapioca IMO, luo-han guo extract, natural vanillin, citric acid and tiger nut product.

According to an embodiment of the present invention, the composition-of-matter presented herein comprises, consists exclusively of, consists essentially of, or consists substantially exclusively of the following ingredients and amounts: an indigestible soluble fiber ingredient at an concentration of about 94-98 wt. %, a natural high-potency sweetening ingredient at an concentration of about 0.5-2.2 wt. %, a flavor-balancing ingredient at an concentration of about 0.1-1 wt. %, a taste-balancing ingredient at an concentration of about 0.1-1.5 wt. %, and tiger nut at an concentration of about 0.5-2 wt. % of the total weight of the composition. In some embodiments, the indigestible soluble fiber ingredient is chicory and/or tapioca IMO, the natural high-potency sweetening ingredient is luo-han guo extract, the taste-balancing ingredient is citric acid, and the flavor-balancing ingredient is natural vanillin.

Process:

According to some embodiments, the composition-of-matter presented herein is manufactures by ordinary techniques for mixing dry, pasted or dissolved ingredients, with water to homogeneity, and drying the resulting slurry or solution by known methods, such as freeze drying or spray drying, while other forms of drying are also contemplated within the scope of the present invention.

In some embodiments, the initial wet mixture is heated to about 75° C. for a time period of about 3 minutes, and thereafter the wet mixture is mixed for another period of about 6 minutes at about 40° C. before further homogenization and drying.

Uses:

In general, the composition-of-matter presented herein can replace sugar in all food product categories, including tabletop products, cooking, baked goods, sweets, hot or cold drinks, dairy products, and the likes. It is noted that the composition-of-matter presented herein can replace sugar in a food product, while the food product is essentially devoid of any added sugars, devoid of any added sugar alcohols, or devoid of any added artificial or synthetic sweeteners.

While serving as a total sugar substitute, the composition-of-matter presented herein is capable of affording food products that are suitable for consumptions by subject that should be under a sugar-restrictive (low sugar) diet. As such, the composition-of-matter presented herein is characterized by inducing a low glycemic response. The combination of sugar-like properties and the low glycemic response induced in humans, renders the composition-of-matter presented herein an advantageous sugar substitute compared to all presently known sugar substitute products.

In some embodiments of the present invention, the composition-of-matter presented herein can be used in beverages, broths, and beverage preparations. In some embodiments of the present invention, the composition-of-matter presented herein can be used in carbonated, non-carbonated, frozen, semi-frozen (“slush”), non-frozen, ready-to-drink, concentrated (powdered, frozen, or syrup), dairy, non-dairy, herbal, non-herbal, caffeinated, non-caffeinated, alcoholic, non-alcoholic, flavored, non-flavored, vegetable-based, fruit-based, root/tuber/corn-based, nut-based, other plant-based, cola-based, chocolate-based, meat-based, seafood-based, other animal-based, algae-based, calorie enhanced, calorie-reduced, and calorie-free products. The amount of the composition-of-matter presented herein in the food product can vary depending on the desired sweetness and other characteristics of the product, so the amount of sweetener used can be adjusted accordingly. In an embodiment, the beverage can include the composition-of-matter presented herein and water, carbonated or non-carbonated water.

In some embodiments of the present invention, the composition-of-matter presented herein can be used in foods and food preparations (e.g., sweeteners, soups, sauces, flavorings, spices, oils, fats, and condiments) from dairy-based, cereal-based, baked goods, vegetable-based, fruit-based, root/tuber/corn-based, nut-based, other plant-based, egg-based, meat-based, seafood-based, other animal-based, algae-based, processed (e.g., spreads), preserved (e.g., meals-ready-to-eat rations), and synthesized (e.g., gels) products. The amount of the composition-of-matter presented herein can vary depending on the desired sweetness and other characteristics of the product, so the amount of sweetener used can be adjusted accordingly.

In some embodiments of the present invention, the composition-of-matter presented herein can be used in candies, confections, desserts, and snacks such as dairy-based, cereal-based, baked, vegetable-based, fruit based, root/tuber/corn-based, nut-based, gum-based, other plant-based, egg-based, meat-based, seafood-based other animal-based, algae-based, processed (e.g., spread;), preserved (e.g., meals-ready-to-eat rations), and synthesized (e.g., gels) products. The amount of the composition-of-matter presented herein can vary depending on the desired sweetness and other characteristics of the product, so the amount of composition-of-matter presented herein used can be adjusted accordingly.

In some embodiments, the composition-of-matter presented herein is used in bread, cakes, cookies, pastries and other baked goods, yogurt, coffee beverage, ice-cream and soft drinks.

In some embodiments of the present invention, the composition-of-matter presented herein can be used in prescription and over-the-counter pharmaceuticals, assays, diagnostic kits, and therapies. In an embodiment, the composition-of-matter can be used in weight control products, nutritional supplement, vitamins, infant diet, diabetic diet, athlete diet, geriatric diet, low carbohydrate diet, low fat diet, low protein diet, high carbohydrate diet, high fat diet, high protein diet, low calorie diet, non-caloric diet, oral hygiene products (e.g., toothpaste, mouthwash, rinses, floss, toothbrushes, other implements), personal care products (e.g., soaps, shampoos, rinses, lotions, balms, salves, ointments, paper goods, perfumes, lipstick, other cosmetics), professional dentistry products in which taste or smell is a factor (e.g., liquids, chewables, inhalables, injectables, salves, resins, rinses, pads, floss, implements), medical, veterinarian, and surgical products in which taste or smell is a factor (e.g., liquids, chewables, inhalables, injectables, salves, resins, rinses, pads, floss, implements), and pharmaceutical compounding fillers, syrups, capsules, gels, and coating products. The amount of the composition-of-matter presented herein can vary depending on the desired sweetness and other characteristics of the product, so the amount of composition-of-matter presented herein used can be adjusted accordingly.

In an embodiment, the composition-of-matter presented herein can be used in goods including table top sweeteners, sweeteners, co-sweeteners, coated sweetener sticks, frozen confection sticks, medicine spoons (human and veterinary uses), dental instruments, pre-sweetened disposable tableware and utensils sachets edible sachets potpourris, edible potpourris, artificial flowers, edible artificial flowers, clothing, edible clothing, massage oils, and edible massage oils. The amount of composition-of-matter presented herein can vary depending on the desired sweetness and other characteristics of the product, so the amount of composition-of-matter presented herein used can be adjusted accordingly.

In an embodiment, the composition-of-matter presented herein can include a tabletop composition that can optionally include bulking agent or anticaking agent or flow agent. In an embodiment, the tabletop composition-of-matter presented herein can be packaged in numerous different forms and it is intended that the tabletop composition-of-matter presented herein may be of any form known in the art. In an embodiment, the tabletop composition-of-matter presented herein can be in the form of a fine powder, a coarse powder, a granular form, packets, tablets, sachets, pellets, cubes, solids, and liquids (e.g., the composition-of-matter presented herein is included in a liquid carrier).

In an embodiment, the composition-of-matter presented herein is a liquid product with properties such that it can be sold commercially. In another embodiment, the liquid composition-of-matter presented herein is dried through a variety of techniques known to those skilled in the art including spray drying, freeze drying and vacuum drying, and foam-mat drying, stored for up to 3 years, then re-distributed into a food product such that the original taste characteristic of the liquid product is maintained.

It is expected that during the life of a patent maturing from this application many relevant variants of the sugar substitute presented herein will be developed and the scope of the terms “sugar substitute” and/or “cane-sugar substitute” are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non-limiting fashion.

### Example 1

Materials:

Lou-han guo (Monk fruit), dried and powdered, was obtained from Julian Bakery Inc. International (alternative sources included monk fruit extract by Monk Fruit Corp., Guangxi, China). Botanical source: Siraitia grosvenorii;

Native inulin powder with increased solubility (Chicory; INULIN S30) was obtained from Oliggo-Fiber®, Cusucra, Belgium. Botanical source: root of Cichorium intybus;

Tiger nut was obtained as a dried and powdered tubes from “The Original Chufa Company” Alboraya, Valencia, Spain. Botanical source: Cyperus esculentus; Vanilla extract was obtained from Poliva, Israel. Botanical source: Vanilla planifolia.

Citric acid was obtained from Sigma IL.

Exemplary Formulation:

Table 1 below presents an exemplary and non-limiting embodiment of the present invention, based on the materials listed above:

TABLE 1

| | Pre-drying | Dry |
|---|---|---|
| Ingredient | contents | contents |
| Tiger nut | 0.33% | 0.96% |
| Native chicory fiber inulin | 32.93% | 96.50% |
| Citric acid | 0.14% | 0.42% |
| Lou-han guo | 0.66% | 1.92% |
| Vanilla extract | 0.07% | 0.19% |
| Water | 65.87% | 0% |
| Total: | 100% | 100% |

Processing:

The formulation presented in Table 1 above was processed as follows:

All ingredients were placed in a Thermomix bowl (Thermomix TM5 by Vorwerk, Netherlands), and mixed at a speed setting of 3.5. The bowl was heated to 75, at which temperature heating was stopped and mixing was continued until the mixture cooled to 40° C.

The mixture was transferred to a homogenizer (APV 1000 2 stage homogenizer) and homogenize at 250 bars. Thereafter approximately 82 gr of the homogenized mixture was placed on a plastic tray, and the tray was placed in a freezer set on −18° C. overnight. The plastic tray was transferred to a freeze dryer (BW-10 multi-pipeline ordinary by Blue wave ind. Co. LTD with vacuum pump by Edwards Model RV1) and dried to water activity of less than 0.2 partial vapor pressure.

After the freeze-drying step, the dry mixture was grinded (Thermomix TM5, set at speed 3.5) and passed through a sieve of 0.5 mm.

### Example 2

Organoleptic Evaluations

In order to evaluate the performance of the presently disclosed embodiment, and compared it to the performance of natural cane sugar, samples of various food products were prepared and evaluated by an expert sensory (organoleptic) panel. As a standard for sugar-like characteristic, natural cane sugar was used to prepare the same products based on essentially the same recipe as those used for the sugar substitute samples.

The objectives of the organoleptic tests was to characterize sensory profiles for different products from three different food categories, in order to test whether the composition-of-matter presented herein has a similar sensory profile to cane sugar, and superior to the compositions disclosed in the prior art.

The food product categories that were tested included:
Butter cookies;
Chocolate cake;
Hot/cold water, pH 6, pH 2.8;
Hot tea; and; and
Cold/Hot coffee with milk.

In each category, a sensory profile was built for the following samples:

A composition-of-matter, according to some embodiments of the present invention, presented in Example 1 hereinabove and denoted 6G335B; and

Plain cane sugar, denoted “sugar”.

The food products were tested among a panel, which included 8-12 tasters. The panel is a universal panel and therefore, for the purpose of adjusting for sugar substitutes tasting, the panel members were trained in training sessions for each category. The training sessions consisted the following subjects:

Building sensory vocabulary for the category;

Learning the tasting protocol for the category in order to calibrate all the tasters to a uniform taste;

Training the panel members on the different attributes intensities; Calibration all the panel members on the scales; and Training on building a sensory profile for the products according to the attributes that were decided on the vocabulary.

After training and calibrating the panel members on each category held another meeting for each category in order to build a sensory profile (a “spider diagram”) for the tested products in each category, according to the attributes that were decided on the sensory vocabulary.

Butter Cookies Category Sensory Profile:

For a batch of 45 small cookies, 175 grams soft butter, 200 grams of 6G335B or sugar, two egg-yolks, 2.5 cups of plain wheat flour, 0.5 ts of baking powder and a small amount of salt. The butter and 6G335B/sugar were mixed in a food processor, and yolks were added thereto. Flour and salt were thereafter added and kneaded to afford homogeneous dough. The dough was flattened to a rounded dick, wrapped with plastic and refrigerated for half an hour. The cooled dough was thereafter cut into small round disks and placed on a baking sheet. The cookies were baked at 175° C. for 8-10 minutes.

Butter cookies were evaluated for properties that are relevant to the product category, and afford a comprehensive comparison relevant to all aspects of the sugar substitute samples, including all sensory attributes, which included color, size, hardness, thickness, crumbling, airiness, melt in mouth, stickiness to teeth, sweetness, butter taste, baking taste, and off-flavor (taste defects).

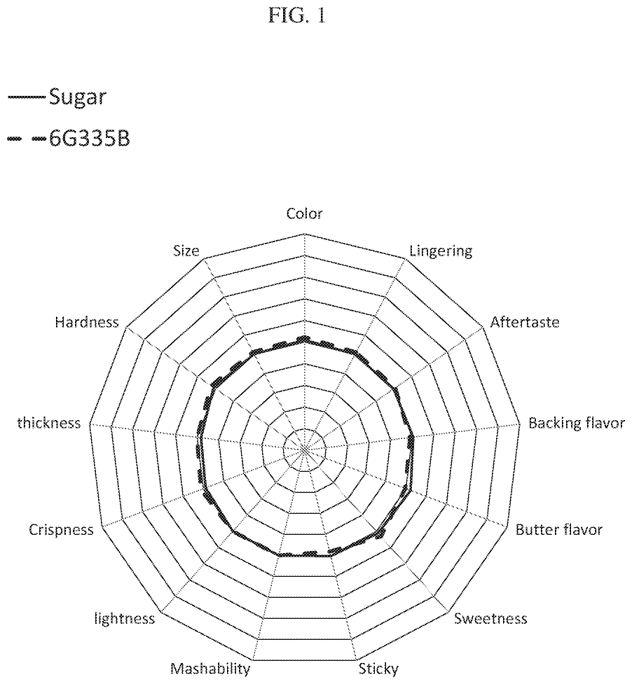

FIG. 1 presents comparative spider diagrams of the sensory profile afforded for butter cookies category comparing 6G335B (dashed line) to Sugar (solid line).

As can be seen in FIG. 1, the sensory profile of the cookies with 6G335B is very similar to that of sugar.

Chocolate Cake Category Sensory Profile: For a batch of 2 English cake forms, 2.5 cups of plain wheat flour, 300 grams of 6G335B or sugar, ⅔ cups of cocoa powder, 2 ts of baking powder, 1 tb sodium bicarbonate powder, 3 eggs, 1 cup of oil and 1 cups of water. All dried ingredients were premixed and eggs, oil and water were added thereto and mixed to afford homogeneous dough. The dough was poured into cake forms and places in an a preheated oven set at 180° C., and baked at 180° C. for 30-35 minutes.

The chocolate cake was evaluated for properties that are relevant to the product category, and afford a comprehensive comparison relevant to all aspects of the sugar substitute samples, including all sensory attributes, which included color, smell, sweetness, bitterness, chocolate taste, crumbling, dryness/moisture, compressible/airiness, mashable, and off-flavor (taste defects).

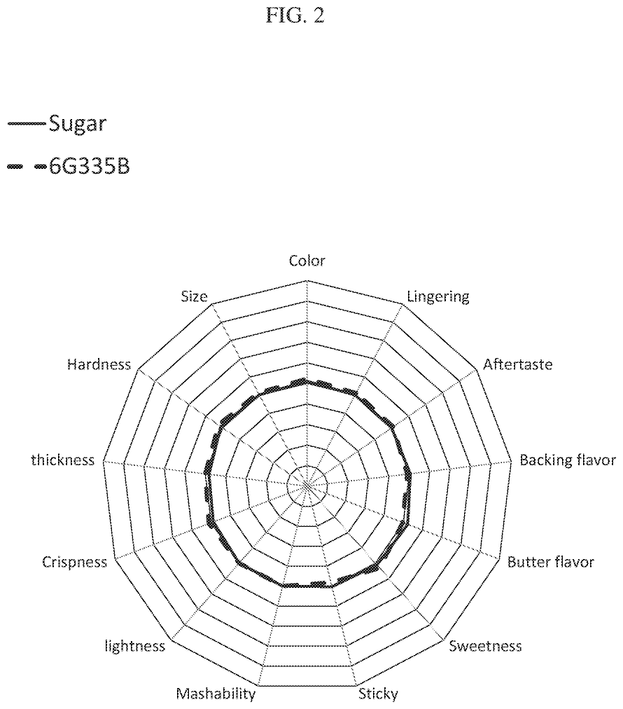

FIG. 2 presents comparative spider diagrams of the sensory profile afforded for chocolate cake category comparing 6G335B (dashed line) to Sugar (solid line).

As can be seen in FIG. 2, the sensory profile of the cake with 6G335B is very similar to the profile of the cake with sugar in most of the sensory attributes.

Hot Tea Category Sensory Profile:

Hot tea was prepared as follows:

For one liter of tea, 5 tb of black Wissotzky Tea, 1,000 ml of hot water, and 75 grams of 6G335B or sugar.

The hot tea was evaluated for properties that are relevant to the product category, and afford a comprehensive comparison relevant to all aspects of the sugar substitute samples, including all sensory attributes, which included color, smell, sweetness, sourness, bitterness, coffee taste, thickness, milkiness, body, and off-flavor (taste defects).

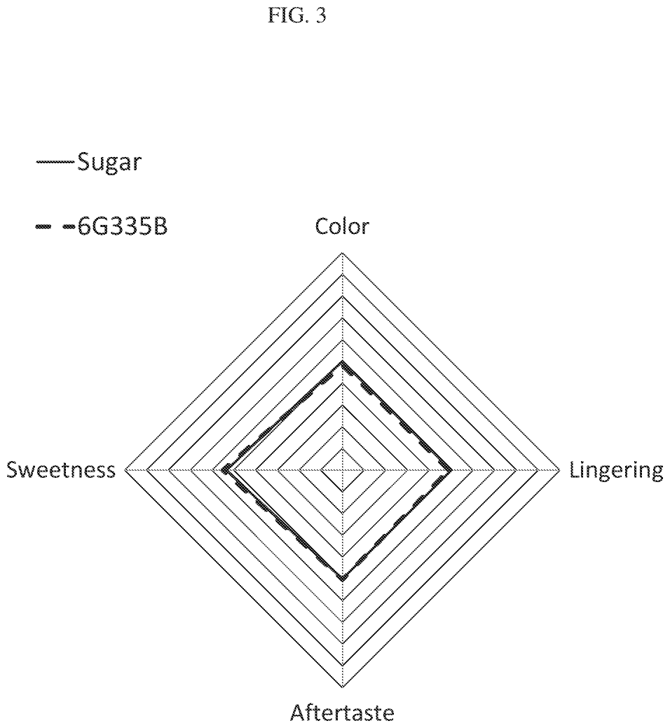

FIG. 3 presents comparative spider diagrams of the sensory profile afforded for hot tea category comparing 6G335B (dashed line) to Sugar (solid line).

As can be seen in FIG. 3, the sensory profile of coffee with 6G335B is very similar to that obtained with sugar.

Cold Coffee with Milk Category Sensory Profile:

For one liter of coffee, 5 tb of Taster's Choice instant coffee, 100 ml of hot water, 100 ml of cold milk, 800 ml of cold water, and 75 grams of 6G335B or sugar. The dry ingredients were combined and dissolved in the hot water, and the cold water was added thereto. Cold coffee was served with ice cubes.

The cold coffee with milk was evaluated for properties that are relevant to the product category, and afford a comprehensive comparison relevant to all aspects of the sugar substitute samples, including all sensory attributes, which included color, smell, sweetness, sourness, bitterness, coffee taste, thickness, milkiness, body, and off-flavor (taste defects).

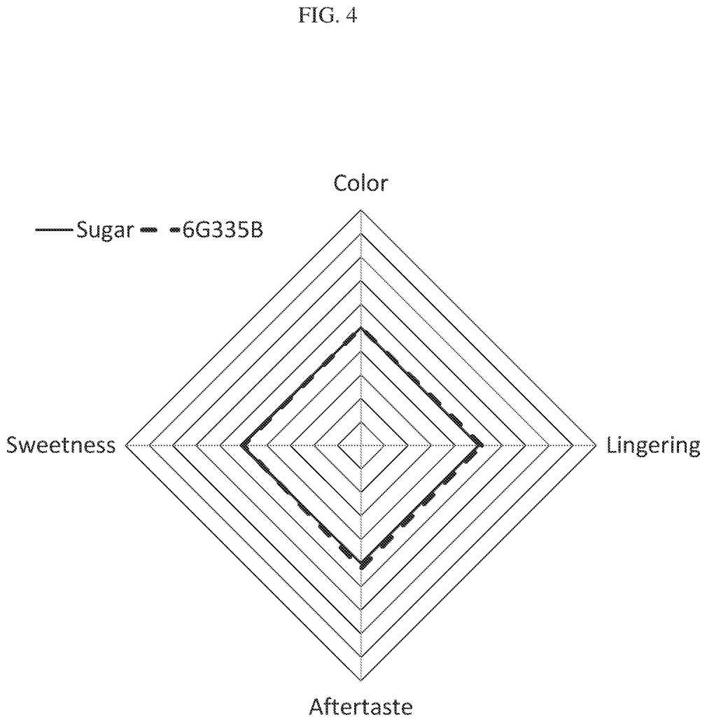

FIG. 4 presents comparative spider diagrams of the sensory profile afforded for cold coffee with milk category comparing 6G335B (dashed line) to Sugar (solid line).

As can be seen in FIG. 4, the sensory profile of coffee with 6G335B is very similar to that obtained with sugar.

Tiger Nut Effect:

The tiger nut effect was tested by comparing a simple yet challenging preparation, hot sweetened water, using the sugar substitute provided herein, the same without tiger nut, and both compared to sugar. Hot sweetened water is a challenging test, since the lack of taste/flavor masking elements and the raised temperature, render the adverse effects harder to ignore by the taster.

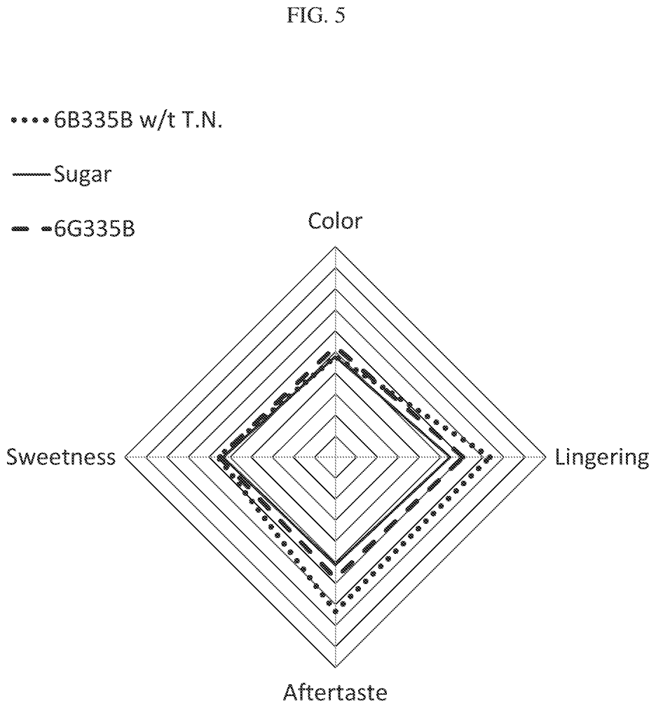

FIG. 5 presents comparative spider diagrams of the sensory profile afforded for cold coffee with milk category comparing 6G335B (dashed line) and 6G335B without tiger nut (dotted line) to Sugar (solid line).

As can be seen clearly in FIG. 5, the test in one of the more challenging formulation, tiger nut seems to be the element that brings the composition closer to sugar in taste and flavor.

Conclusions: The results of the organoleptic sensory tests demonstrate that the composition-of-matter presented herein are capable of replacing sugar in all food categories.

### Example 3

Exemplary Formulations:

The following is a formulation that mimics sucrose sweetening properties in two ways: a formulation having the sweetening properties “by volume”, and another formulation useful for “by weight” applications. Each formulation may be more compatible in different markets—for example, the home market where users measure sugar mainly by volume, and the industrial market, where users weigh each ingredient in a given recipe.

It was found that the following recipe best duplicated the sweetening properties of sugar when used as weighted substitution:

TABLE 2

| Formula A1 | Wt. % |
|---|---|
| Water | 63.6 |
| instant inulin | 31.8 |
| Monk fruit extract | 3.6 |
| Tiger nut | 1.0 |

It was found that the following recipe best duplicated the sweetening properties of sugar when used as a “by weight formulation:

TABLE 3

| Formula B1 | Wt. % |
|---|---|
| Water | 63.4 |
| instant inulin | 31.7 |
| Monk fruit extract | 3.9 |
| Tiger nut | 1.0 |

Determining the sweetening properties of the formula was conducted by dissolving the formulated compositions in water and comparing the sweetening properties to a sugar-based reference using a panel of five trained sensory tasters. More specifically, for the “by weight” formula A1: 4 gr of castor sugar, commercially available product produced by Sugat LTD, Israel, were dissolved in 200 ml of tap water at 60° C. The solution was evaluated by the panel with a second preparation of 4 gr. of formula A1 that was also dissolved in 200 ml of tap water at 60° C.

The sensory evaluation was performed using samples warmed/cooled to 40° C. It was found that the sweetening properties of the formula A1 resembled closely that of plain cane sugar, weight per weight.

Using similar methodology the “by volume” formula B1 was compared to commercially available cane castor sugar by Sugat LTD, Israel. Four ml of the dry samples (commercial cane sugar and formula B1) were dissolved in 200 ml of tap water at 60° C., cooled to 40° C. and evaluated by a panel of five trained sensory tasters. It was found that the sweetening properties of formula B1 resembled closely that of commercially available cane sugar, volume per volume.

A Natural Botanic Antioxidant Additive:

Using an antioxidant was considered as an additive in the composition-of-matter provided herein, since low water activity may enhance oxidation in food products. Table 4 presents an exemplary formulation comprising a natural botanic antioxidant in the form green tea extract.

TABLE 4

| Formula C1 | Wt. % |
|---|---|
| Water | 63.4 |
| Instant Inulin | 31.7 |
| Monk Fruit concentrate | 3.9 |
| Green tea extract | 0.01% |
| Tiger nut | 1.01% |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A composition-of-matter, comprising:
an indigestible soluble fiber ingredient,
a natural high-potency sweetening ingredient,
a tiger nut product.

2. (canceled)

3. The composition-of-matter of claim 1, wherein said indigestible soluble fiber ingredient is selected from the group consisting of an isomaltooligosaccharide, an inulin, a digestive resistant dextrin, and a digestive resistant maltodextrin.

4. The composition-of-matter of claim 1, wherein said natural high-potency sweetening ingredient is selected from the group consisting of a Siraitia grosvenorii derived substance, a luo-han guo extract, a mogroside and esgoside.

5. The composition-of-matter of claim 1, wherein said tiger nut product ingredient is selected from the group consisting of powdered tiger nuts, sliced/chopped tiger nuts and mashed tiger nuts.

6. (canceled)

7. The composition-of-matter of claim 1, further comprising an organic acid.

8. The composition-of-matter of claim 7, wherein said organic acid is citric acid.

9. The composition-of-matter of claim 1, wherein:
a concentration of said indigestible soluble fiber ingredient ranges 94-98 weight percent;
a concentration of said natural high-potency sweetening ingredient ranges 0.5-2.2 weight percent; and
a concentration of said tiger nut product ingredient ranges 0.5-2 weight percent of the total weight of the composition-of-matter.

10. The composition-of-matter of claim 9, wherein:
said indigestible soluble fiber ingredient is chicory and/or tapioca isomaltooligosaccharide; and
said natural high-potency sweetening ingredient is luo-han guo extract.

11. (canceled)

12. The composition-of-matter of claim 1, substantially devoid of a sugar alcohol.

13. The composition-of-matter of claim 1, substantially devoid of an artificial or synthetic sweetener.

14. The composition-of-matter of claim 1, substantially devoid of a steviol glycoside, or any Stevia rebaudiana-derived substance.

15. (canceled)

16. The composition-of-matter of claim 1, packaged in a packaging material and identified in print for use as a sugar substitute.

17. The composition-of-matter of claim 16, wherein a mass and/or volume unit of the composition-of-matter is equivalent to said mass and/or volume unit of sugar.

18. A food product comprising the composition-of-matter of claim 1.

19. The food product of claim 18, substantially devoid of a sugar alcohol.

20. The food product of claim 18, substantially devoid of an artificial or synthetic sweetener.

21. The food product of claim 18, substantially devoid of a steviol glycoside, or any Stevia rebaudiana-derived substance.

22. (canceled)

23. The food product of claim 18, selected from the group consisting of a pastry product, a dairy product, a beverage, and a cooked product.

24. (canceled)
